(19) United States
(12) Patent Application Publication
(10) Pub. No.: US 2010/0324949 A1
(43) Pub. Date: Dec. 23, 2010

(54) TRANSFORMING GENERIC BUSINESS MEASURE DEFINITIONS INTO EXECUTABLE MONITORING SPECIFICATIONS

(75) Inventors: Wei Huang, Thornhill (CA); Grace H. Y. Lo, Markham (CA); Curtis R. Miles, Markham (CA); Yaqing Zhang, Toronto (CA)

Correspondence Address: CAREY, RODRIGUEZ, GREENBERG & PAUL, LLP;STEVEN M. GREENBERG, 950 PENINSULA CORPORATE CIRCLE, SUITE 2022, BOCA RATON, FL, 33487, US

(73) Assignee: INTERNATIONAL BUSINESS MACHINES CORPORATION, Armonk, NY (US)

(21) Appl. No.: 12/488,685

(22) Filed: Jun. 22, 2009

(51) Int. Cl. G06Q 10/00

(52) U.S. Cl. 705/7

(57) ABSTRACT

A business process management (BPM) data processing system can be provided. The system can include a business process modeler executing in memory of a host server and a process generation engine coupled to the business process modeler and configured to generate an executable business process execution model from a business process model defined by the business process modeler. The system further can include a monitoring generation engine coupled to the business process modeler and configured to generate an executable monitoring model using business measures mapped to emittable events in the executable business process execution model and using logic enabled to compute metrics for the business measures from data in the events, both the business measures and logic being defined separately from and irrespective of the business process model.

### CROSS-REFERENCE TO RELATED APPLICATIONS

This application claims priority under 35 U.S.C. §119(a) to Canadian Patent Application Serial Number ______, filed Jun. 18, 2009, entitled “TRANSFORMING GENERIC BUSINESS MEASURE DEFINITIONS INTO EXECUTABLE MONITORING SPECIFICATIONS”, the entirety of which is incorporated herein by reference.

### BACKGROUND OF THE INVENTION

1. Field of the Invention

The present invention relates to the field of business process management (BPM) and more particularly to monitoring business measure information for an executing business process model.

2. Description of the Related Art

A business process is a collection of related, structured activities that produce a service or product that meet the needs of a client. Business processes are critical to a business organization as they generate revenue and often represent a significant proportion of costs. Business process management (BPM) is a method of efficiently organizing and managing a business organization so as to meet its business objectives. BPM promotes business effectiveness, efficiency, innovation, flexibility and integration with technology. BPM further attempts to continuously improve business processes. Business process optimization includes retrieving process performance information, identifying potential or actual bottlenecks, cost savings or other improvements and then applying those improvements in the design of the business process through BPM.

Business Activity Monitoring (BAM) refers to computer software configured to aid in the monitoring of business processes, as those processes are implemented in computer systems. BAM specifically refers to the aggregation, analysis, and presentation of real time information about business processes inside organizations and involving customers and partners. Accordingly, BAM is an enterprise solution primarily intended to provide a real-time summary of business processes to operations managers and upper management. The main benefits of BAM including the enablement of an enterprise to make better informed business decisions, quickly address problem areas, and re-position organizations to take full advantage of emerging opportunities.

One feature of BAM solutions includes the presentation of information on visual “dashboards” that present business measures used to monitor and provide feedback on the performance of an executing business process. In this regard, in the context of business process models, individual business measures can provide information as to health of the process as it is executing or the degree to which the business process is achieving the business goals. Business measures, also referred to in the art as key performance indicators (KPIs), thus are used to provide assurance and visibility of business activity and performance. This information is used by to provide visibility, measurement, and assurance of important business processes as well as to detect and warn of impending problems.

Just as business process information can be described in a generic, high level, and runtime-agnostic form, so too can the information that describes and defines business measures to be collected and displayed. However, unlike a business process, no formal method has been defined for transforming generic business measure information into a format that can be executed within a monitoring runtime environment specifically designed for tracking business measure information. Current solutions, such as the conventional BAM, involve a manual mapping of the generic business measure to corresponding elements of a business process. Current solutions further require development by a computing professional to provide implementation details for the generic business measures to render the business measures executable. In the context of business measures created for particular process models, this involves (among other things) manual identification of the events emitted during the execution of an executable business process and a manual mapping to the specification of the executable process.

### BRIEF SUMMARY OF THE INVENTION

Embodiments of the present invention address deficiencies of the art in respect to the transformation of business measure definitions into an executable format and provide a novel and non-obvious method, system and computer program product for a process for the automated transformation of generic business measure definitions based on a generic business process model into a corresponding executable monitoring specification based on the executable process model. In an embodiment of the invention, a method for the automated transformation of generic business measure definitions based on a generic business process model into a corresponding executable monitoring model for a specific executable business process execution model can be provided. The method can include generating an executable business process execution model from a business process model defined by business process modeler executing in memory by a processor of a host server. The method additionally can include further generating an executable monitoring model for the executable business process execution model using business measures mapped to emittable events in the executable business process execution model and using logic enabled to compute metrics for the business measures. Of note, both the business measures and logic are defined separately from and irrespective of the business process model

Finally, the method can include executing each of the executable business process execution model and the executable monitoring model in a BPM server executing in memory by a processor of a host server. The executable monitoring model during execution can thus monitor the business measures in events emitted by the executable business process execution model and can calculate the metrics from the business measures. In an optional aspect of the embodiment, in further generating an executable monitoring model for the executable business process execution model, a template of a set of business measures generically defined in association with emittable events can be parsed and the set of business measures can be mapped to business measures specified within the business process model. Locations for the emittable events can be determined from a descriptor generated from the executable business process execution model. Finally, the executable monitoring model can be generated for the business measures specified within the business process model to monitor business measures mapped to the emittable events of the executable business process execution model at respective locations specified by the descriptor.

In another embodiment of the invention, a BPM data processing system can be provided. The system can include a business process modeler executing in memory of a host server and a process generation engine coupled to the business process modeler and configured to generate an executable business process execution model from a business process model defined by the business process modeler. The system further can include a monitoring generation engine coupled to the business process modeler and configured to generate an executable monitoring model using business measures mapped to emittable events in the executable business process execution model and using logic enabled to compute metrics for the business measures, both the business measures and logic being defined separately from and irrespective of the business process model. In an optional aspect of the embodiment, a BPM server is configured to execute both the executable business process execution model and the executable monitoring model. In consequence, the executable monitoring model during execution can monitor the business measures in events emitted by the executable business process execution model and calculating the metrics from the business measures.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for automated transformation of generic business measure definitions based on a generic business process model into a corresponding executable monitoring specification based on the executable process model;

FIG. 2 is a schematic illustration of a BPM data processing system configured for automated transformation of generic business measure definitions based on a generic business process model into a corresponding executable monitoring specification based on the executable process model; and,

FIG. 3 is a flow chart illustrating a process for automated transformation of generic business measure definitions based on a generic business process model into a corresponding executable monitoring specification based on the executable process model.

### DETAILED DESCRIPTION OF THE INVENTION

Embodiments of the present invention provide a method, system and computer program product for automated transformation of generic business measure definitions based on a generic business process model into a corresponding executable monitoring specification based on the executable process model. In accordance with an embodiment of the present invention, business measures can be defined generically to include a template of a set of business measures and metrics information to be derived from the business measures, irrespective of a particular business process model, and also logic requisite to computing the metrics information based upon the business measures as recognized from events emitted by business model elements of an executable business process execution model generated for a business process model. A descriptor for business model elements in a business process execution model generated for a specific business process model by a business process execution engine can be used to map the set of business measures and metrics information of the defined business measures to the business model elements in the executable business process execution model—namely events emitted by the business model elements.

Thereafter, an executable monitoring model can be generated from the mapping, the template and one or more defined business measures specific to the generated business process execution model as specified in a specific business process model from which the business process execution model had been generated. The generated executable business process execution model for the specific business process model can be executed in a BPM server. Likewise, the executable monitoring model can be executed in the BPM server to monitor performance of the generated process execution model. In this way, the executable monitoring model can be generated from generic business measure definitions in a way that is specific to the events to be emitted by a mapped executable business process execution model without requiring tedious manual tooling of the executable monitoring model.

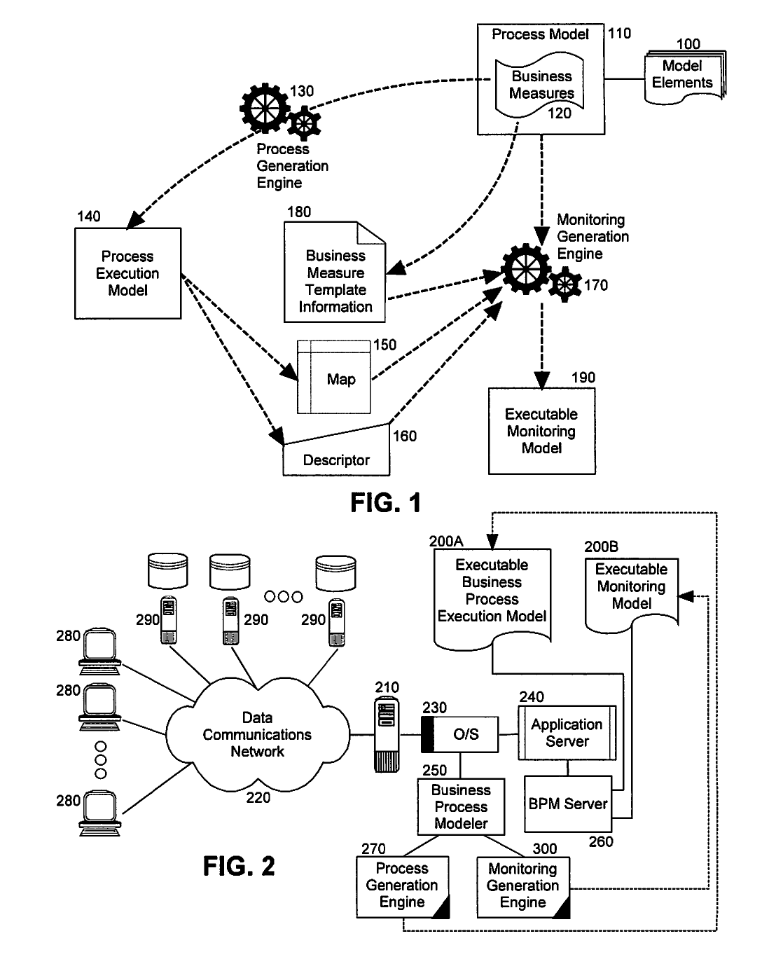

In further illustration, FIG. 1 pictorial depicts a process for automated transformation of generic business measure definitions based on a generic business process model into a corresponding executable monitoring specification based on the executable process model. As shown in FIG. 1, a business process model 110 can be specified to include multiple different model elements 100. Additionally, different business measures 120 can be defined for the business process model 110 to be monitored during execution of an executable form of the business process model 110, and metrics to be computed for the business process model 110 from the monitored business measures. Business measure template 180 can be defined separately to include a set of business measures and metrics able to be computed according to logic specified within the business measure template 180. Of note, the business measure template 180 is defined without regard to an implementation of a particular business process model.

A process generation engine 130 can generate an executable business process execution model 140 as is well known in the art according to the specified business process model 110 including the different model elements 100. However, in accordance with an embodiment of the invention, a monitoring generation engine 170 further can generate an executable monitoring model 190 based upon the business measure template 180 and the business measures 120 defined for the specified business process model 110. In this regard, a monitor application descriptor (MAD) 160 can be derived from the generated executable business process execution model 140 describing the events to be emitted by the executable business process execution model 140 and the location of those events to be emitted. Further, a map 150 can be referenced by the monitoring generation engine 170 to correlate the events emitted from the generated executable business process execution model 140 according to the MAD 160 to the business measures 120 to be collected for the executable business process execution model 140. Finally, the business measure template 180 can be used by the monitoring generation engine 170 to determine specific logic requisite to computing the metrics required by the business measures 120 as captured from data in events emitted from the executable business process execution model 140. The resulting executable monitoring model 190 upon execution can monitor events emitted from the executable business process execution model 140 during execution of the executable business process execution model 140, extract the data from those emitted events, and compute the required metrics for the executable business process execution model 140.

In yet further illustration, FIG. 2 is a schematic illustration of a BPM data processing system configured for automated transformation of generic business measure definitions based on a generic business process model into a corresponding executable monitoring specification based on the executable process model. The system can include one or more host servers 210, each with at least one processor and memory. The host server 210 can support the execution of operating system 230 through which application server 240 can operate. A business process modeler 250 can execute in the host server 210 and the BPM server 260 can execute in the application server 240. The business process modeler 250 can be configured to accept a visually and/or textually specified representation of different model elements of a business process model, different remote data sources 290, such as remotely disposed database management systems, and a visually and/or textually specified representation of different relationships between the model elements of the business process model and the remote data sources 290. A process generation engine 270 of the business process modeler 250 thereafter can be configured to generate an executable business process execution model 200A based upon the specified representations, for execution by the BPM server 260.

Of note, a monitoring generation engine 300 can be coupled to the business process modeler 250. The monitoring generation engine 300 can include program code which when loaded into memory and executed can be enabled to parse business measures specified for the business process model, a template of business measures, event sources for the business measures, and the logic necessary to compute metrics from the business measures received from the event sources, and also a descriptor of the generated executable business process execution model 200A describing locations for the event sources. The program code of the monitoring generation engine 300 further can be configured to generate an executable monitoring model 200B based upon the business measures specified for the business process model according to the template and descriptor by way of a mapping of the events to be emitted by model elements of the generated executable business process execution model 200A to the logic of the template.

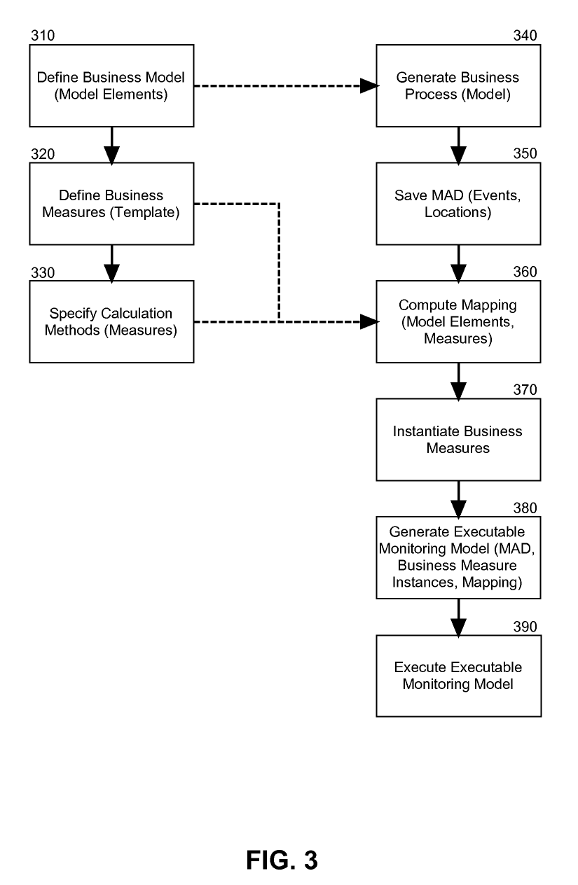

In yet further illustration of the operation of the BPM data processing system of FIG. 2, FIG. 3 is a flow chart illustrating a process for automated transformation of generic business measure definitions based on a generic business process model into a corresponding executable monitoring specification based on the executable process model. Beginning in block 310, a business process model can be defined to include different interrelated model elements. The business process model further can be defined to include one or more business measures to be monitored upon execution of an executable business process model generated from the business process model. In block 320, a generic template of business measures and event sources for the business measures can be defined irrespective of any particular business process model. In block 330, different methods of calculating metrics from the business measures can be specified in the template.

In block 340, an executable business process execution model can be generated from the business process model using a process generation engine as is well known in the art. In block 350, a descriptor can be determined and stored for the executable business process execution model including different events able to be emitted by the executable business process execution model and the location of those events. In block 360, a mapping can be determined for the different business measures to be monitored for different model elements of the business process model in the executable business process execution model, with respect to the locations of the events to be emitted by the executable business process execution model. Thereafter, in block 370, instances of program logic enabled to acquire the business measures specified for the business process model according to the methods specified in the template and the locations of the events specified by the descriptor can be created and in block 380, an executable monitoring model can be generated from the different instances. Finally, in block 390 the executable monitoring model can be executed to monitor the events of the generated executable business process execution model.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for the automated transformation of generic business measure definitions based on a generic business process model into a corresponding executable monitoring model for a specific executable business process execution model, the method comprising:
generating an executable business process execution model from a business process model defined by business process modeler executing in memory by a processor of a host server;
further generating an executable monitoring model for the executable business process execution model using business measures mapped to emittable events in the executable business process execution model and using logic enabled to compute metrics for the business measures, both the business measures and logic being defined separately from and irrespective of the business process model; and,
executing each of the executable business process execution model and the executable monitoring model in a business process management (BPM) server executing in memory by a processor of a host server, the executable monitoring model during execution monitoring data in events emitted by the executable business process execution model and calculating the metrics from the data.

2. The method of claim 1, wherein further generating an executable monitoring model for the executable business process execution model, comprises:
parsing a template of a set of business measures generically defined in association with emittable events;
mapping the set of business measures to business measures specified within the business process model;
determining locations for the emittable events from a descriptor generated from the executable business process execution model; and,
generating the executable monitoring model for the business measures specified within the business process model to monitor business measures mapped to the emittable events of the executable business process execution model at respective locations specified by the descriptor.

3. The method of claim 2, further comprising:
identifying in the template logic enabled to compute metrics from the data; and,
incorporating the logic as part of the executable monitoring model.

4. A business process management (BPM) data processing system comprising:
a business process modeler executing in memory of a host server;
a process generation engine coupled to the business process modeler and configured to generate an executable business process execution model from a business process model defined by the business process modeler; and,
a monitoring generation engine coupled to the business process modeler and configured to generate an executable monitoring model using business measures mapped to emittable events in the executable business process execution model and using logic enabled to compute metrics for the business measures from data in the events, both the business measures and logic being defined separately from and irrespective of the business process model

5. The system of claim 4, further comprising a BPM server configured to execute both the executable business process execution model and the executable monitoring model, the executable monitoring model during execution monitoring data for the business measures in events emitted by the executable business process execution model and calculating the metrics from the data.

6. A computer program product comprising a computer usable medium embodying computer usable program code for the automated transformation of generic business measure definitions based on a generic business process model into a corresponding executable monitoring model for a specific executable business process execution model, the computer program product comprising:
computer usable program code for generating an executable business process execution model from a business process model defined by business process modeler executing in memory by a processor of a host server;
computer usable program code for further generating an executable monitoring model for the executable business process execution model using business measures mapped to emittable events in the executable business process execution model and using logic enabled to compute metrics for the business measures, both the business measures and logic being defined separately from and irrespective of the business process model; and,
computer usable program code for executing each of the executable business process execution model and the executable monitoring model in a business process management (BPM) server executing in memory by a processor of a host server, the executable monitoring model during execution monitoring data in events emitted by the executable business process execution model and calculating the metrics from the data.

7. The computer program product of claim 6, wherein the computer usable program code for further generating an executable monitoring model for the executable business process execution model, comprises:
computer usable program code for parsing a template of a set of business measures generically defined in association with emittable events;
computer usable program code for mapping the set of business measures to business measures specified within the business process model;
computer usable program code for determining locations for the emittable events from a descriptor generated from the executable business process execution model; and,
computer usable program code for generating the executable monitoring model for the business measures specified within the business process model to monitor business measures mapped to the emittable events of the executable business process execution model at respective locations specified by the descriptor.

8. The computer program product of claim 7, further comprising:
computer usable program code for identifying in the template logic enabled to compute metrics from the data; and,
computer usable program code for incorporating the logic as part of the executable monitoring model.
